(19) United States
(12) Patent Application Publication
(10) Pub. No.: US 2019/0031305 A1
(43) Pub. Date: Jan. 31, 2019

(54) CONTAINER SHIP

(71) Applicant: A.P. Møller - Mærsk A/S, København K (DK)

(72) Inventor: Troels POSBORG, Horsens (DK)

(21) Appl. No.: 16/147,369

(22) Filed: Sep. 28, 2018

Related U.S. Application Data
(63) Continuation of application No. PCT/EP2017/057579, filed on Mar. 30, 2017.

(30) Foreign Application Priority Data
Mar. 31, 2016 (DK) PA201670183

(51) Int. Cl. B63B 49/00; B63B 25/28; G05D 1/02

(52) U.S. Cl. CPC B63B 49/00; B63B 2213/00; G05D 1/0206; B63B 25/28

(57) ABSTRACT

A container ship configured for stowing a plurality of shipping containers above the open deck. The container ship comprises at least one digital video camera arranged to capture a field of view forward of the forward of bow of the container ship, a bridge provided with instruments for direction control, instruments for engine control, and with at least one display screen coupled to the at least one digital video camera for real time reproduction of images captured by the digital video camera.

### CROSS-REFERENCE TO RELATED APPLICATIONS

This application is a continuation, under 35 U.S.C. § 120 of International Application No. PCT/EP2017/057579, filed Mar. 30, 2017, which claims priority to Danish Application No. DK PA201670183 filed Mar. 31, 2016 under 35 U.S.C. § 119(a). Each of the above-referenced patent applications is incorporated by reference in its entirety.

### BACKGROUND OF THE INVENTION

### Field of the Invention

The disclosure relates to a container ship, i.e. a marine vessel configured for storage and transport of a large number of shipping containers, the disclosure relates in particular to a container ship with an increased capacity for stowing shipping containers.

### Background

Container ships are marine vessels (cargo ships) that are designed and constructed for transporting shipping containers (intermodal container). Typically, container ships carry all of their load in truck-size intermodal containers. Container ships are a common means of commercial intermodal freight transport and now carry most seagoing non-bulk cargo. Container ship capacity is measured in twenty-foot equivalent units (TEU). Typical loads are a mix of 20-foot and 40-foot (2-TEU) ISO-standard containers, with the latter predominant.

Shipping containers are stowed in the hull, i.e. below the open deck and above the open deck of a container ship. In the longitudinal direction of the container ship storage spaces divided into bays, in the transverse direction of the container ship the storage spaces divided in a number of rows and in the vertical direction the store space is divided in a number of horizontal container layers or tiers.

The shipping containers are stowed as high as possible with some container ships operating with up to ten or eleven tiers above the open deck. However, the above deck bays located closest to the bow the maximum number of tiers that can be used is reduced in order to provide a free line of sight/visibility from the bridge to the surface of the water ahead of the container ship, as illustrated in FIGS. 1 and 2. FIG. 1 shows a so-called twin island container ship in which the bridge and crew facilities are arranged in a tower that is separate from the engine funnels. FIG. 2 shows a single island container ship in which the bridge, crew facilities and engine funnels are combined. The interrupted line 7 illustrates the line of sight from the bridge to the water surface. Maritime regulations require a field of view to the sea surface forward of the bow of the container ship that starts at a distance d that is less than the lesser of two ship lengths or 500 m forward of the bow of the container ship. Since the height of the bridge cannot be increased without negative consequences, such as the inability to pass under road bridges or railroad bridges and other fixed constructions, it has been necessary to stow fewer tiers of containers in the forwardly located container bays, which can be clearly seen in FIGS. 1 and 2.

The bridge of a ship is the room or platform from which the ship can be controlled or commanded. When a ship is underway the bridge is manned by an 00W (officer of the watch) aided usually by an AB (able seaman) acting as lookout. During critical manoeuvres the captain will be on the bridge supported, perhaps, by an 00W as an extra set of hands, an AB on the wheel and sometimes a pilot if required.

The bridge is located on its own superstructure for ships of the so-called twin island design as shown in FIG. 1 and the bridge is combined with the funnel(s) for the engine(s) in the so-called single island design as shown in FIG. 2. The length and space occupied by the superstructure of the bridge and the superstructure of the funnels or by the combined superstructure cannot be used for stowing containers.

### SUMMARY

It is an object of the invention to provide system that overcomes or at least reduces the problems indicated above.

The foregoing and other objects are achieved by the features of the independent claims. Further implementation forms are apparent from the dependent claims, the description and the figures.

According to a first aspect, there is provided a container ship configured for stowing a plurality of shipping containers above the open deck, said container ship comprising: at least one optical sensor arranged to capture one or more images of a viewing field of view forward of the forward of bow of the container ship wherein at least a part of the viewing field of view is a blindspot which is not in direct line of sight from a bridge, wherein the bridge is provided with: instruments for direction, instruments for engine, and at least one display coupled to said at least one optical sensor for real time reproduction of the one or more images including the blindspot captured by said optical sensor.

By providing a container ship with at least one optical sensor such a digital video camera arranged to capture a field of view that cannot be seen from the bridge, such as e.g. the area directly forward of the bow of the container ship and by displaying the images captured by the optical sensor on a display screen or the like on the bridge it becomes possible to locate the bridge at any desirable location in the container ship, even in a location where there is no outside view you to the outside, and allow the crew of the container ship to control/command the container ship from the bridge. Being able to place the bridge at any desired location on the container ship while still providing the required visual and possibly this information allows the flow area of the open deck to be used for stowing containers without the height of the containers stowed above deck being limited by a line of sight from a conventional bridge to the sea surface forward of the bow. These new possibilities allow a significant increase in the number of containers that can be stowed on a container ship of a given size.

In a first possible implementation form of the first aspect the bridge is not provided with any windows that provide a view of the area ahead of the container ship.

In a second possible implementation form of the first aspect the at least one optical sensor is arranged such that it provides a field of view to the sea surface forward of the bow of the container ship that starts at a distance that is less than the lesser of two ship lengths or 500 m forward of the container ship.

In a third possible implementation form of the first aspect the said at least one optical sensor is arranged such that it provides a field of view to the sea surface forward of the bow of the container ship that starts at a distance that is less than the lesser of two ship lengths or 500 m forward of the bow to at least 10° on either side under all conditions of draught, trim and containers stowed on deck.

In a fourth possible implementation form of the first aspect the at least one digital video camera is placed on the container ship such that the view of the at least one digital video camera to the area forward of the container ship is substantially unobstructed by any part of the container ship, and preferably not obstructed either by any containers stowed on the open deck of the container ship.

In a fifth possible implementation form of the first aspect the container ship is configured for storage of shipping containers above the open deck arranged in a plurality of bays distributed over the length of the container ship, arranged in a plurality of rows distributed over the width of the container ship and arranged in a plurality of tiers in the direction of the height of the container ship, with the at least one optical sensor being arranged such that it provides for an unobstructed view of the area ahead of the container ship regardless of the number of tiers of shipping containers that are stowed in the most forwardly located bays.

In a sixth possible implementation form of the first aspect the container ship is provided with one or more of optical sensors for providing a substantially 360° horizontal field of view/vision around the container ship, the bridge preferably being provided a plurality of display screens that are arranged in a substantially circular or polygon arrangement for real time reproduction of the substantially 360° horizontal field of view to a crew member on the bridge inside the circular or polygon arrangement.

In a seventh possible implementation form of the first aspect the container ship is provided with one or more optical sensors for providing a substantially 360° horizontal field of view and a 180° vertical view and said bridge is provided with a display arrangement with a plurality of screens arranged on a semi-sphere covering said bridge.

In an eighth possible implementation form of the first aspect the container ship is provided with a plurality of microphones arranged for capturing sound around the container ship and wherein the bridge is provided with acoustical transducers for real time reproduction of the sound captured by the microphones.

In a ninth possible implementation form of the first aspect the container ship is provided with a plurality of microphones arranged for directional capturing of sound around the container ship wherein the bridge is provided with acoustical transducers for real time reproduction of the directional sound captured by the microphones in a way that allows a crew member on the bridge to determine from which direction the recorded sound came.

In a tenth possible implementation form of the first aspect the container ship is provided with sound processing equipment coupled to the microphones and configured to determine the distance to the source of sound captured with the microphones, the bridge preferably being provided with an instrument or display screen to indicate the distance to the source of sound.

In a eleventh possible implementation form of the first aspect the container ship is provided with a maneuvering console, the maneuvering console preferably comprising one or more of the following instruments: a steering wheel for controlling the rudder, handles for controlling the engine power, an indicator for the propeller speed, am indicator for the direction of rotation of the propeller, an indicator of the rudder angle, an indicator of the speed of the container ship, a compass.

In a twelfth possible implementation form of the first aspect, wherein the bridge is located below the open deck.

In a thirteenth possible implementation form of the first aspect the container ship is configured for stowing shipping containers above the open deck up to a predetermined maximum height, and wherein the bridge is located below the predetermined maximum height.

In a fourteenth possible implementation form of the first aspect the container ship is configured for stowage of containers a maximum number of tiers above the open deck, resulting in the a predetermined maximum height.

In a fifteenth possible implementation form of the first aspect the at least one optical sensor is a digital video camera, preferably a 3D video camera, such as a dual video camera or a stereo video camera, and wherein said at least one display screen is preferably configured to display 3D video according to a second aspect, there is provided a method of commanding a container ship, the method comprising providing a real-time view of the area ahead of the container ship on a display screen on a bridge of the container ship and issuing directional and/or engine control commands from the bridge.

In a sixteenth possible implementation form of the first aspect the container ship is provided with a radar for detecting the wave systems ahead of the container ship.

In a seventeenth possible implementation form of the first aspect the at least one optical sensor is a digital video camera for generating an image stream.

According to a second aspect there is provided a method of commanding a container ship, said method comprising providing a real-time view of the area ahead of said container ship captured with an optical sensor on a display screen on a bridge of said container ship and issuing directional and/or engine control commands from said bridge.

In a first possible implementation form of the second aspect a crew member on the bridge observing the display screen and a crew member issuing the directional and/or engine control commands from the bridge.

In a second possible implementation form of the second aspect the bridge is not provided with any windows that allow a crew member on the bridge a view of the area ahead of the container ship.

In a third possible implementation form of the second aspect the method comprises capturing a substantially 360° horizontal view around the container ship and reproducing the captured substantially 360° horizontal view on a display screen or array of display screens surrounding an area of the bridge, the area preferably being provided with a maneuvering console.

In a fourth possible implementation form of the second aspect the method comprises capturing sound around the container ship and reproducing the captured sound with at least one acoustical transducer on the bridge.

In a fifth possible implementation form of the second aspect the sound is captured directionally, preferably 360° horizontal around the container ship, and wherein the captured sound is reproduced through a plurality of spatially distributed acoustic transducers on the bridge such that a crew member on the bridge can determine from which direction the recorded sound came.

In a sixth possible implementation form of the second aspect the method comprising capturing video with depth information of the area ahead of the bow of the container ship and displaying the captured video with depth information in 3D on said at least one display screen on said bridge.

These and other aspects will be apparent from and the embodiment(s) described below.

### BRIEF DESCRIPTION OF THE DRAWINGS

In the following detailed portion of the present disclosure, the aspects and implementations will be explained in more detail with reference to the example embodiments shown in the drawings, in which:

FIG. 1 is a side view of a prior art container ship of the so-called twin island design;

FIG. 2 is a side view of a prior art container ship of the so-called single island design,

FIG. 3 is a stern view of the container ship of FIG. 2,

FIG. 4 is a stern view of a container ship according to a first embodiment,

FIG. 5 is a side view of the container ship of FIG. 4,

FIG. 6 is a diagrammatic top view of the container ship of FIG. 4 showing a video camera arrangement,

FIG. 7 is a diagrammatic top view of the container ship of FIG. 4 showing a microphone arrangement,

FIG. 8 is a top view of a bridge of the container ship of the first embodiment of FIG. 4,

FIG. 9 is an elevated view of a part of the bridge of FIG. 8,

FIG. 10 is a block diagram of the system of the container ship of the embodiment of FIG. 4, and

FIG. 11 a side view of another embodiment of the container ship.

### DETAILED DESCRIPTION OF CERTAIN INVENTIVE EMBODIMENTS

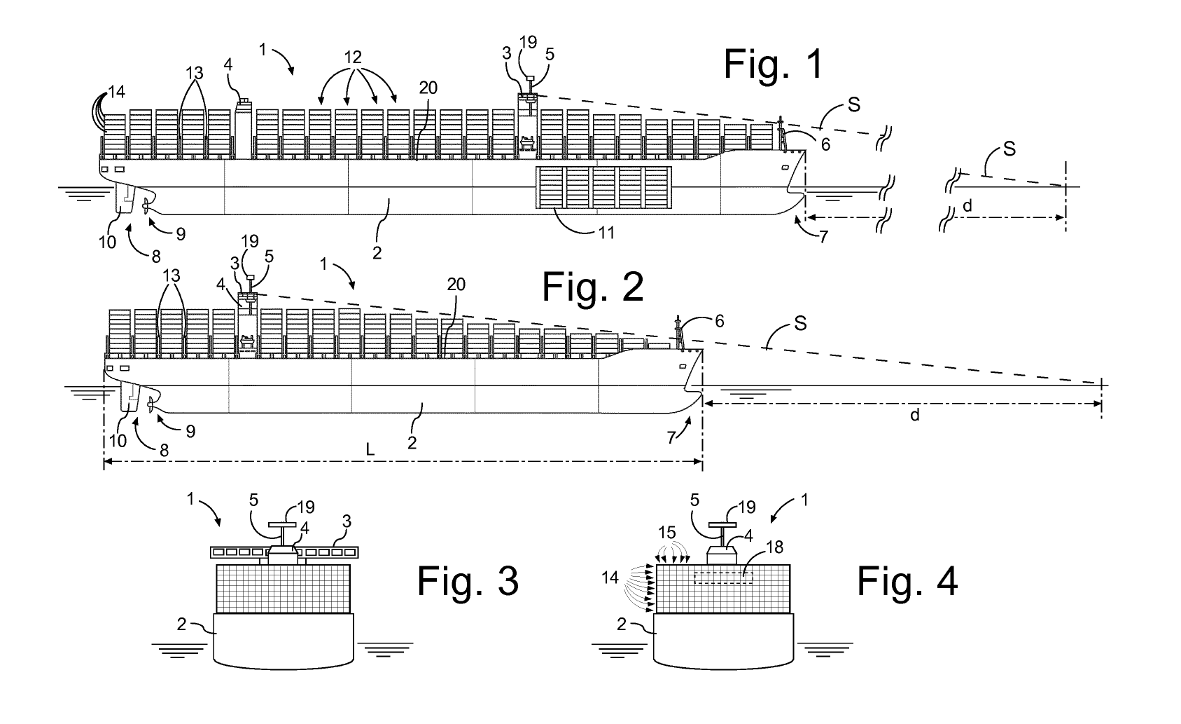

FIGS. 1 and 3 show a prior art, i.e. conventional container ship 1, i.e. a ship that is suitable for stowing and transporting a large number of shipping containers, in a side view and stern view, respectively. Whilst the term container ship is used throughout, the invention may be applicable to other types of vessel or ships.

The container ship 1 comprises a hull 2 that extends over the full length of the container ship 1 between the bulbous bow 7 and the stern 8. The hull 2 houses one or more engine rooms, fuel tanks and other facilities required for the operation of the container ship 1. A major part of the hull 2 is used for stowing containers as shown by the cutaway view 11. The container ship 1 is provided with one or more large compression-ignited internal combustion engines for propulsion, i.e. four-stroke or two-stroke compression-ignited combustion engine(s) driving the propellers(s) 9 and there will be one or more auxiliary engines (generator sets) that provide electrical power and heat for various consumers of electrical power and heat aboard the container ship 1. One or more rudders 10 provide for directional control of the container ship 1.

The large ocean going cargo ship 1 is provided with a bridge 3 and one or more funnels 4. In the embodiment of FIG. 1 the superstructure of the bridge 3 is separate from the superstructure of the funnels 4, and therefore the design of this type of container ship 1 is called “twin island”.

The bridge 3 is provided with windows for a view to the outside and with a maneuvering console with instruments and controls for commanding the container ship 1.

A foremast 6 is provided at the bow 7 and a radar mast 5 is placed on top of the bridge 3 for carrying the radar antenna 19. An open deck 20 forms the top of the hull 2.

Containers are stowed inside the hull 2 and on the open deck 20 in a plurality of bays 12 distributed over the length of the container ship 1. The stowed containers are arranged in a plurality of rows 15 distributed over the width of the container ship 1 and arranged in a plurality of tiers 14 in the direction of the height of the container ship 1. The bays 12 are separated by lashing bridges 13. The lashing bridges extend approximately 4 tiers high and serve to secure the containers by lashing.

FIG. 2 is a side view of another prior art container ship that is similar to the container ship of FIG. 1, except that the container ship 1 of FIG. 2 is of the so-called single island design in which the bridge 3 and the funnel 4 are a combined structure. Since the funnel 4 has to be placed close to the main engine and since the main engine has to be close to the propeller 9 the bridge 3 of the single island design needs to be placed closer towards the stern 8 than to the bow 6, when compared to the twin island design of FIG. 1.

In the prior art container ships the crew accommodation (not shown) is typically provided in one of the superstructures.

Maritime regulations require that the view of the sea surface from the navigating and maneuvering workstation, i.e. from the bridge 3, shall not be obscured by more than two ship lengths L, or 500 m, whichever is the less, forward of the bow to 10° on either side under all conditions of draught, trim and deck cargo, e.g. containers. On a container ship 1 the fulfillment of this criterion depends on the height of the bridge 3, the longitudinal position of the bridge 3 and the height the stack of containers in the most forwardly located container bays 12, i.e. the number of tiers 14 in most forwardly located container bays 12. This relation is exemplified by the line of sight/visibility S in FIGS. 1 and 2, and by the length d of the area of the sea surface forward of the bow that is obscured from view for an observer on the bridge 3. The bridge 3 cannot be placed arbitrarily high, otherwise the container ship 1 is not be able to pass under road- and railway bridges and other fixed constructions above waterways. Therefore, it has been necessary in conventional container ships to operate with fewer tiers 14 of shipping containers in the forwardly located shipping container bays 12, when compared to the more rearwardly located container bays that have up to eight or nine tiers.

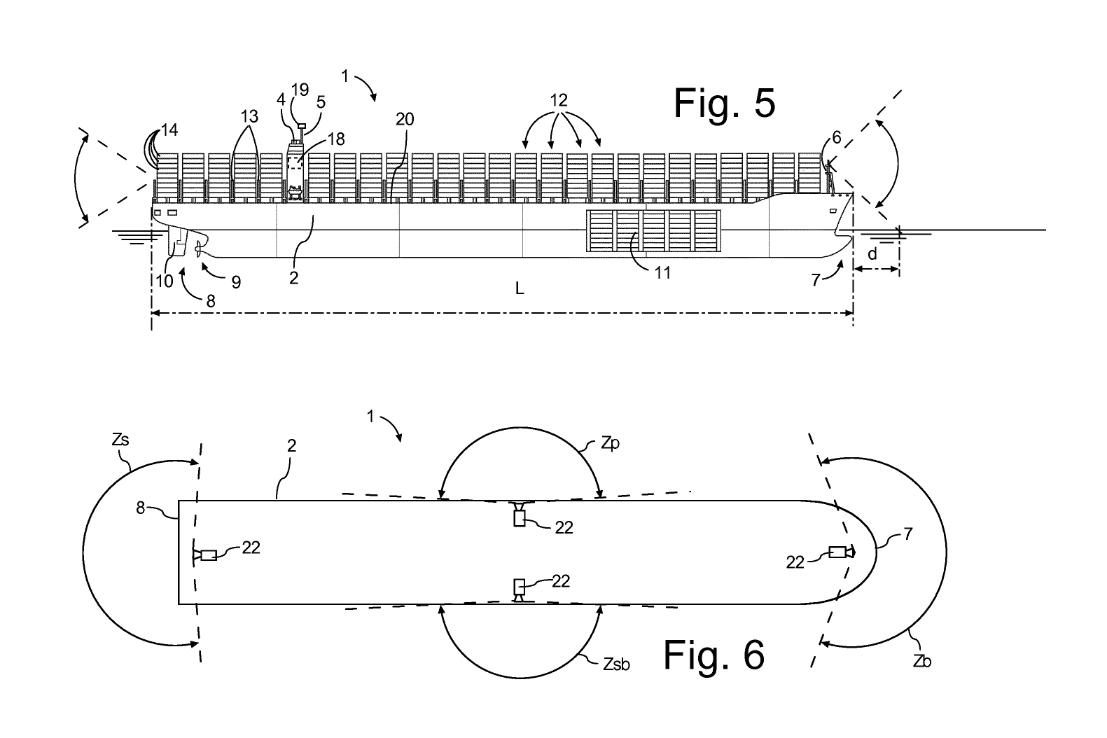

FIGS. 4 and 5 illustrate a container ship 1 according to a first embodiment in stern view and side view, respectively. The container ship 1 according to the first embodiment is essentially identical to the container ship of FIGS. 1 and 2, with the following exceptions.

The conventional bridge 3 has been removed and replaced by a bridge 18 that is not located on the top of a superstructure. Instead, the bridge 18 is located inside the superstructure that also houses the funnel 4 and supports the radar mast 5 with the radar antenna 19 but it is noted that the bridge 18 could just as well be located inside the hull 2. Thus, the bridge 18 is placed above the open deck 20 at a height that is lower than the maximum height of containers stowed on the open deck 20 or the bridge 18 is placed below the open deck 20. In the first embodiment the bridge 18 is shown inside the superstructure together with the funnel 4, and the bridge 18 is indicated by a dotted line because the bridge 18 does not have and does not need to have any windows to the open and the bridge 18 is therefore not visible from the outside.

The crew accommodation (not shown) is preferably placed in the superstructure.

The container ship 1 is provided with one or more optical sensors for capturing at least one image. The optical sensor is configured to capture optical information forward of the container ship for reproduction at another point on the container ship. In some embodiments the optical sensors are configured to capture a stream of images forming a video stream. In some embodiments the optical sensors are a digital video camera 22 that is arranged to capture images (video) of the field of view forward of the bow 7. This digital video camera can be a 3D camera or a conventional 2D camera. In some embodiments the optical sensors can be analogue video cameras or any other suitable means for capturing optical information. In an embodiment the optical sensor such as the digital video camera operates in the visible spectrum, but it is also possible to operate with a camera outside the visible spectrum (such as an infrared or night vision camera) or with a camera that operates both inside visible spectrum and outside the visible spectrum.

In an embodiment the digital video camera is installed at or near the top of the foremast 6, a position that provides for an unhindered view of the sea surface forward of the bow 7 regardless of the height of the containers stowed on the open deck 20. In FIG. 6 a possible angle of view and a vertical direction for the digital video camera 22 at the bow 7 is indicated, preferably the digital video camera has a relatively wide-angle in the vertical field, e.g. 90° or more so that the length d of the obscured area ahead of the bow 7 is short and at the same time the good view in the higher area is provided. The horizontal field of view of the digital video camera 22 should preferably be relatively wide, with an angle of view Zb that is preferably above 180°, even more preferably at least 225°, as illustrated in FIG. 6.

The field of view of the digital video camera includes at least a part of the viewing field of view is a blindspot which is not in direct line of sight from a bridge. This means that the reproduction of the image in the bridge provides images or videos of the blindspots from the bridge. This makes control and movement of the ship from the bridge easier.

As illustrated in FIG. 6, the container ship 1 can be provided with another digital video camera 22 at the stern 8 that is configured to capture images (video) of the field of view rearward of the stern 8. Preferably, the digital video camera 22 at the stern 8 is also a wide angle video camera, as illustrated by the horizontal angle of view Zs. Further, the container ship one can be provided with a port side digital video camera 22 that is configured to capture images (video) of the field of view to the port side of the container ship 1. The port side digital video camera 22 is preferably also a wide-angle camera, as illustrated by the angle Zp. A wide-angle star board video camera 22 can also be provided, as illustrated by the wide-angle Zsb. The four digital video cameras 22 form together a camera arrangement that provides a 360° horizontal field of view around the container ship 1.

In the present embodiment the arrangement comprises four cameras, but it is understood that a single camera with a 360° horizontal view could be used instead of a plurality of cameras with a combined view of 360°. A larger number of cameras can also be used to provide a camera arrangement with a 360° horizontal view around the container ship 1.

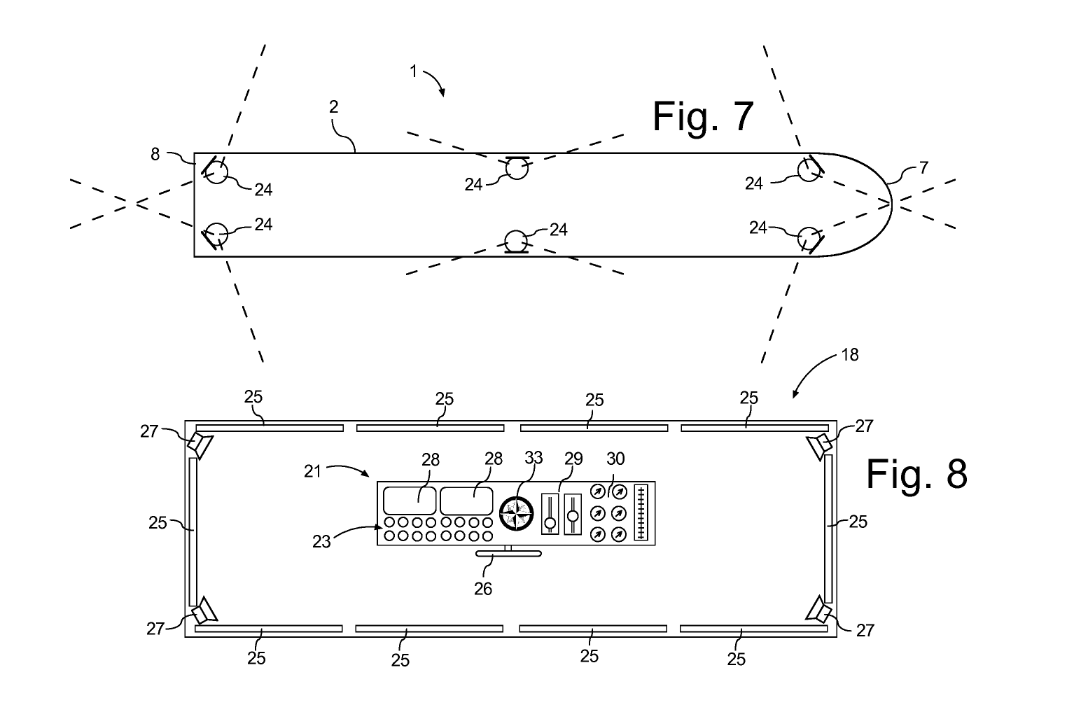

FIG. 7 is a diagrammatic top view of the container ship 1 illustrating a microphone arrangement for picking up sounds around the container ship 1, such as e.g. sound signals and fog horn from other ships. The container ship 1 is provided with several microphones 24, preferably directional microphones 24 that are positioned along the periphery of the container ship 1 in order to pick up sound in a 360° field of hearing. In FIG. 7 an array with six microphones 24 is shown. The interrupted lines illustrate the hearing angle of each of the microphones 24. However, it is understood that any number of microphones 24 can be used, such as for example a single 360° microphone that is placed centrally on the container ship 1 or an arrangement including more than six directional microphones 24.

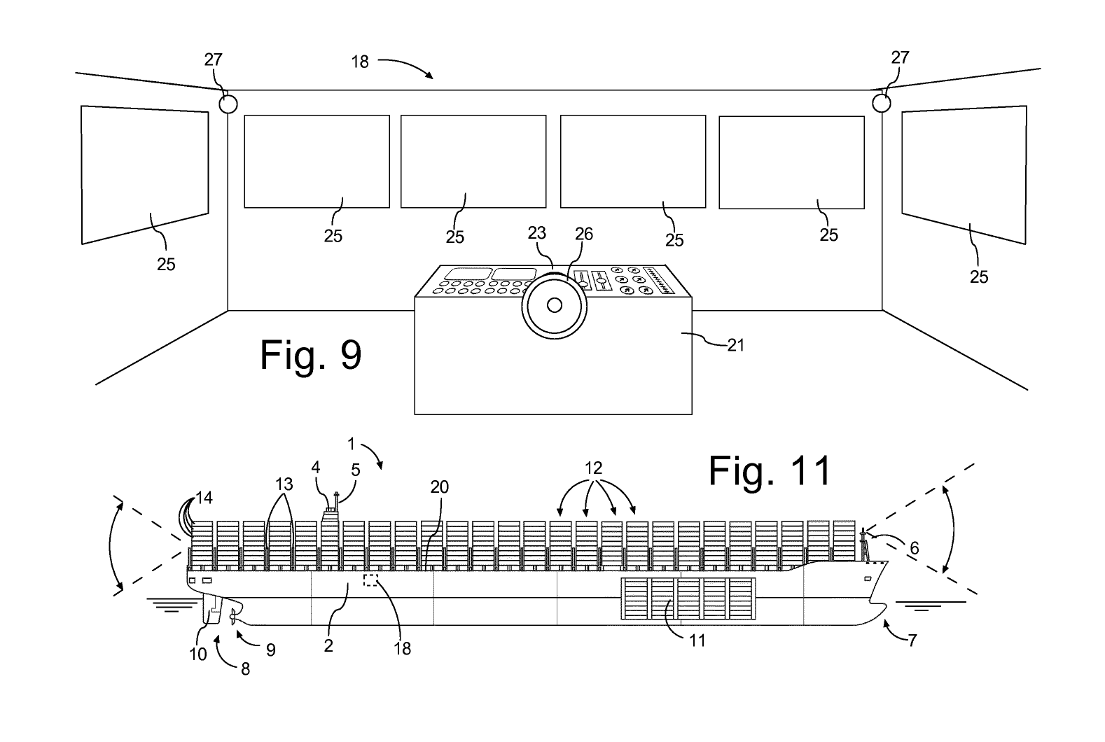

FIG. 8 is a top view of the bridge 18 and the FIG. 9 is an elevated view of a portion of the bridge 18. The bridge 18 is provided with an, as such, conventional maneuvering console 21 with the usual instruments of a conventional bridge, such as a steering wheel 26, display screens 28 for navigation and RADAR, control knobs 23 for setting of various equipment, handles (telegraph) 29 for controlling the load and speed of the main engine(s) and gauges 34 displaying various measured parameters/properties. The maneuvering console 21 is placed at substantially centrally on the bridge and a plurality of display screens 25 is arranged circumferentially around the maneuvering console 21.

Loudspeakers 27 are spatially distributed so as to be placed circumferentially around the maneuvering console 21.

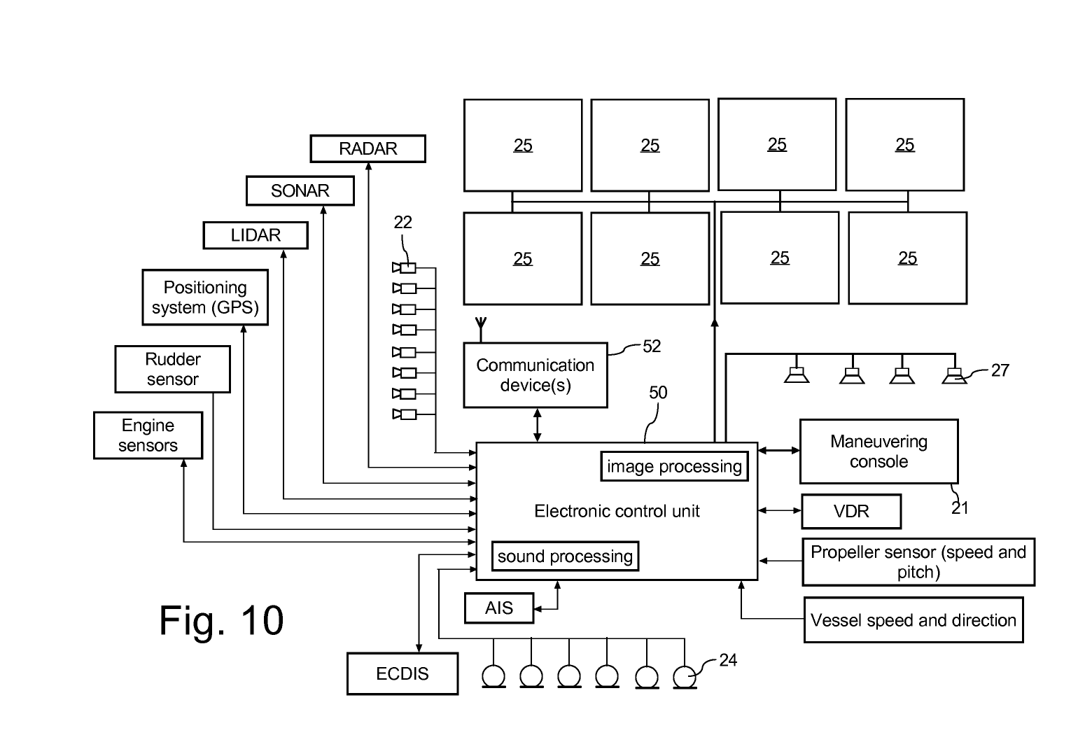

FIG. 10 is a block diagram of system on the bridge 18 and the equipment connected thereto. The system includes an electronic control unit 50 that is connected to RADAR, SONAR, LIDAR (laser scanning), a position system (GPS), a rudder sensor, engine sensors, to ECDIS (Electronic Chart Display and Information System), the digital video cameras 22, the directional microphones 24, IAS (Automatic Identification System), VDR (wage data recorder), the maneuvering console 21, the loudspeakers 27, the display screens 25, wireless communication device(s) 52, propeller speed and pitch sensor, vessel speed and direction sensor and compass 33. The connection between the electronic control unit 50 and these devices/instruments can be wired, e.g. via signal cables or wireless.

The electronic control unit 50 is configured to display the information received from the connected sensors and devices on the instruments, display screens 28, gauges 30 of the maneuvering console.

The bridge 18 may also be provided with further instruments, display screens and gauges (is not shown) that are located on the bridge but not on the maneuvering console, such as overhead instrumentation (not shown) and instrumental other consoles (not shown) on the bridge 18.

Further, the bridge 18 can be provided with information on maneuvering characteristics of the container ship 1; these include propeller speed in RPM and the container ship's speed in knots corresponding to full, half, slow, and dead slow ahead positions on the telegraph. The compass 33 can be a standard magnetic compass, steering magnetic compass, or gyrocompass or combination thereof.

The steering wheel 26 may operate a telemotor transmitter. Rudder angle indicators are provided on the maneuvering console 21. The bridge 18 can be provided with weather monitoring systems and with an automatic identification system (ASI), i.e. a system to transmit/receive the information on ships', name, position, course, speed, destination, cargo etc. by digital radio technology to ships in the area of the potential 1. The bridge 18 may also be provided with ARPA: Automatic Radar Plotting Aid displays the position of the container ship 1 and other vessels nearby.

The RADAR displays the position of the ships in the vicinity and selects the course for the vessel by avoiding any kind of collision. The container ship 1 may also be provided with an echo Sounder (SONAR): an instrument is used to measure the depth of the water below the container ship's bottom using sound waves. The container ship can also be provided with a GPS Receiver, or similar receiver for another satellite-based positioning system: to determine the container ship's location with the help of positioning satellites in the earth's orbit.

The electronic control unit 50 is in receipt of the signal from the digital video cameras and the electronic control unit 50 comprises, or has associated therewith, an image processing unit or image processing software for processing the signals captured from the array of video cameras in order to present the visual information captured by the array of video cameras on the array of display screens 25. Further, the display screens are configured to provide depth information, i.e. 3D video. The image processing unit/processing software is configured such that a crew member on the bridge, e.g. position near the maneuvering console will have a 360° view of the surroundings of the container ship by looking at the array of display screens 25 around him/her. Preferably, the bridge is oriented in a similar way to a conventional bridge with the display screens 25 on the opposite side of the maneuvering console 21 relative to the steering wheel 26 displaying a view of the area ahead of the container ship 1, the display screens on the side of the maneuvering console 21 that is provided with the steering wheel 26 displaying the area behind the container ship 1, the display screen(s) 25 on the star board side of the maneuvering console 21 displaying the star board view and the display screen(s) 25 on the port side of the maneuvering console displaying the port side view captured by the camera arrangement.

The display screens 25 can be part of a pair of glasses (not shown), worn the crew member on the bridge 18. The pair of glasses is preferably capable of displaying 3D video of the video captured by the cameras 22. The glasses preferably include a sensor that detects the orientation in which the glasses are directed and an electronic controller connected to the glasses is configured to display the field of view captured by the camera arrangement corresponding to the orientation of the glasses, so that the crew member wearing the glasses will e.g. be presented with the forward view captured by the camera arrangement when the glasses are directed in the forwardly (relative to the orientation of the container ship 1), be presented with a rearward view captured by the camera arrangement when the classes are directed rearwardly, and so on for the other viewing directions.

The electronic control unit 50 is also provided with a sound processing unit/sound processing software that is configured to process the sounds captured by the array of directional microphones 24. The captured sounds are processed by the sound processing unit/sound processing software in such a way that they are reproduced by the loudspeakers 27 in a spatial manner, so that the crew member on the bridge will be able to hear from which the direction the sound is coming. The sound processing unit/sound processing software is configured to determine the distance of the source of a captured sound, and is configured to indicate the distance of the captured sound on instruments on the bridge 18. In order to determine the distance to the captured sound, the electronic control unit 50 is configured to combine information from radar and/or camera array and/or LIDAR and/or, position data in combination with geographical information with the signal from the camera array. The microphones 24 are configured to cover at least the human hearing spectrum, but in an embodiment the microphones 24 cover a broader spectrum and the sound processing unit/software is configured to convert the audio signal recorded outside the human hearing spectrum to information that can be detected by the crew, for example to information within the hearing spectrum or information represented on instruments or a display screen.

The video captured by the camera arrangement is reproduced on the display screens 25 real time, so that a crew member on the bridge 18 has a real-time 360° view of the surroundings of the container vessel 1. The sound/audio captured by the microphone arrangement is reproduced real-time by the loudspeaker arrangement so that a crew member on the bridge has a real-time spatial audio information of the surroundings of the container vessel 1.

With this audiovisual information the crew on the bridge 18 is well informed in real time about the surroundings of the container ship 1 and therefore fully capable of commanding the container ship 1 from the bridge 18. On top of the visual and audio information of the surroundings of the container ship 1 the crew on the bridge 18 is information from other sources such as RADAR, LIDAR, SONAR and GPS. The crew on the bridge 18 has the required instrumentation, in the form of the maneuvering console, for commanding the container ship 1. Directional controls (rudder) and engine power can be controlled directly from the bridge 18. Consequently, the bridge 18 does not need to be provided with any windows that provide a view to the outside, thus allowing the bridge 18 to be located in the container ship 1 without the need for the bridge to be located above the containers stowed on the open deck 20. It is therefore an advantage of the container vessel according to this disclosure that the forwardly located container bays can be stowed with eight or nine tiers of containers without detrimental effect on the forward visibility for the crew on the bridge 18.

In an embodiment, not shown the container ship provided with the camera arrangement providing a substantially 360° horizontal field of view and a substantially 180° vertical view and the bridge 18 is provided display arrangement with a plurality of screens arranged on a semi-sphere covering the bridge 18.

In an embodiment the VDR is configured to record the video captured by the cameras 22 or at least the video displayed on the display screens 25 and/or the sound recorded by the microphones 24 or at least the sound reproduced by the loudspeakers 27.

In an embodiment the container ship 1 is provided with a wave radar (not shown) for detecting the wave systems ahead of the container ship 1. The wave radar provides information for a navigator on the bridge 18 or other crew member via e.g. a display screen on the bridge 18 to judge if ship speed should be reduced in order to ensure safe navigation. The wave radar judges significant wave height (which is the measure used to characterize sea state) on a statistical basis, which is better (more precise) that a judgment by human eye, be it a human eye observing the wave system directly or via a video camera and display screen.

In an embodiment the cameras 24, the connection between the cameras 24 and the bridge 18, the microphones 24 and the bridge equipment such as the display screens 25 and the electronic equipment for controlling an coordinating, such as the electronic control unit 50 are provided on the container vessel 1 at least twice for redundancy, so that the crew on the bridge 18 will still have access to the visual and audio information should one of these systems inadvertently fail.

In an embodiment the electronic control unit 50 uses augmented reality is to display (overlay) the approx. origin and distance of a source of a sound on one or more of the display screens, e.g. in the form if a circle and a line from the container ship 1 the area indicating the distance to the source of sound. The overlay is preferably applied to a navigational map and/or radar plot.

FIG. 11 shows a container ship according to a second embodiment that is essentially identical to the container ship of the first embodiment with the difference that the bridge 18 is located in the hull 2, i.e. below the open deck 20 and the space next to the funnel 4 is used to a container bay on each side of the funnel, thereby further increase the container stowing capacity of the container ship 1.

The invention has been described in conjunction with various embodiments herein. However, other variations to the disclosed embodiments can be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. A single processor or other unit may fulfill the functions of several items recited in the claims. The mere fact that certain measures are recited in mutually different dependent claims does not indicate that a combination of these measured cannot be used to advantage.

The reference signs used in the claims shall not be construed as limiting the scope.

1. A container ship configured for stowing a plurality of shipping containers above the open deck, said container ship comprising:
at least one optical sensor arranged to capture one or more images of a viewing field of view forward of the bow of the container ship wherein at least a part of the viewing field of view is a blindspot which is not in direct line of sight from a bridge,
wherein the bridge is provided with:
instruments for direction,
instruments for engine, and
at least one display coupled to said at least one optical sensor for real time reproduction of the one or more images including the blindspot captured by said optical sensor.

2. A container ship according to claim 1, wherein said at least one optical sensor is arranged such that it provides a field of view to the sea surface forward of the bow of the container ship that starts at a distance that is less than the lesser of two ship lengths or 500 m forward of the container ship.

3. A container ship according to claim 2, wherein said at least one optical sensor is arranged such that it provides a field of view to the sea surface forward of the bow of the container ship that starts at a distance that is less than the lesser of two ship lengths or 500 m forward of the bow to at least 10° on either side under all conditions of draught, trim and containers stowed on deck.

4. A container ship according to claim 1, wherein said at least one optical sensor is placed on the container ship such that the view of the at least one optical sensor of the area forward of the container ship is substantially unobstructed by any part of the container ship.

5. A container ship according to claim 1, wherein said container ship is configured for storage of shipping containers above the open deck arranged in a plurality of bays distributed over the length of the container ship, arranged in a plurality of rows distributed over the width of the container ship and arranged in a plurality of tiers in the direction of the height of the container ship, with said at least one optical sensor being arranged such that it provides for an unobstructed view of the area ahead of the container ship regardless of the number of tiers of shipping containers that are stowed in the most forwardly located bays.

6. A container ship according to claim 1, provided with one or more of optical sensors for providing a substantially 360° horizontal field of view around the container ship.

7. A container ship according to claim 1, provided with one or more optical sensors for providing a substantially 360° horizontal field of view and a 180° vertical view and said bridge is provided with a display arrangement with a plurality of screens arranged on a semi-sphere covering said bridge.

8. A container ship according to claim 1, provided with a plurality of microphones arranged for capturing sound around the container ship and wherein said bridge is provided with acoustical transducers for real time reproduction of the sound captured by said microphones.

9. A container ship according to claim 1, provided with a plurality of microphones arranged for directional capturing of sound around the container ship wherein said bridge is provided with acoustical transducers for real time reproduction of the directional sound captured by said microphones in a way that allows a crew member on said bridge to determine from which direction the recorded sound came.

10. A container ship according to claim 8, further provided with sound processing equipment coupled to said microphones and configured to determine the distance to the source of sound captured with said microphones.

11. A container ship according to claim 1, provided with a maneuvering console.

12. A container ship according to claim 1 wherein the at least one optical sensor is a digital video camera for generating an image stream.

13. A method of commanding a container ship, said method comprising providing a real-time view of the area ahead of said container ship captured with an optical sensor on a display screen on a bridge of said container ship and issuing directional and/or engine control commands from said bridge.

14. A method according to claim 13, comprising capturing a substantially 360° horizontal view around the container ship and reproducing the captured substantially 360° horizontal view on a display screen or array of display screens surrounding an area of said bridge.

15. A method according to claim 13, comprising capturing sound around said container ship and reproducing said captured sound with at least one acoustical transducer on said bridge.

16. A method according to claim 14, wherein the area of the bridge is provided with a maneuvering console.

17. A container ship according to claim 4, wherein said at least one optical sensor is placed on the container ship such that the view of the at least one optical sensor of the area forward of the container ship is not obstructed either by any containers stowed on the open deck of said container ship.

18. A container ship according to claim 6, wherein the bridge is provided with a plurality of display screens that are arranged in a substantially circular or polygon arrangement for real time reproduction of said substantially 360° horizontal field of view to a crew member on said bridge inside said circular or polygon arrangement.

19. A container ship according to claim 10, wherein the bridge is provided with an instrument or display screen to indicate the distance to said source of sound.

20. A container ship according to claim 11, wherein the maneuvering console comprises one or more of the following instruments: a steering wheel for controlling the rudder, handles for controlling the main engine power or load, an indicator for the propeller speed, an indicator of the rudder angle, an indicator of the speed of the container ship, a compass.
